(19) United States
(12) Patent Application Publication
(10) Pub. No.: US 2023/0312154 A1
(43) Pub. Date: Oct. 5, 2023

(54) CONTROL METHOD IN A PRODUCTION PROCESS FOR ARTICLES AND A PRODUCTION APPARATUS FOR ARTICLES OPERATING ACCORDING TO THIS METHOD

(71) Applicant: G.D S.P.A., BOLOGNA (IT)

(72) Inventors: Andrea BIONDI, BOLOGNA (IT); Luca CAVAZZA, BOLOGNA (IT); Umberto ZANETTI, BOLOGNA (IT); Enrico CAMPAGNOLI, BOLOGNA (IT); Antonio GIGANTE, BOLOGNA (IT); Giacomo NOFERINI, BOLOGNA (IT); Cristian DAKESSIAN, BOLOGNA (IT); Gianluca PARISINI, BOLOGNA (IT); Marco FIORENTINI, BOLOGNA (IT)

(21) Appl. No.: 18/006,565

(22) PCT Filed: Jul. 26, 2021
(86) PCT No.: PCT/IB2021/056725

§ 371 Date: Jan. 23, 2023

(30) Foreign Application Priority Data
Aug. 7, 2020 (IT) 102020000019759

(51) Int. Cl. B65B 57/04; B65B 43/50; B65B 29/02; B65B 65/00

(52) U.S. Cl. CPC B65B 57/04; B65B 43/50; B65B 29/022; B65B 65/003

(57) ABSTRACT

A method for controlling a production process for articles includes: feeding a plurality of articles to a first operating unit where the articles are subjected to a first processing operation; controlling at least one characteristic of the articles outgoing from the first operating unit; identifying among the outgoing articles a first group and a second group of articles, in which the at least one characteristic is respectively in accordance or not with predetermined quality parameters; transferring the articles outgoing from the first operating unit to at least one second operating unit, where the articles are subjected to at least one second processing operation; allowing the at least one second operating unit to perform the at least one second processing operation on the first group of articles; receiving the articles outgoing from the at least one second operating unit, and then discarding the second group of articles.

The present invention relates to a method for controlling the quality of articles in a production process. It is also directed to a production apparatus intended to operate according to this method.

The present invention finds a preferred, though not exclusive, application in the field for preparing and packaging food and non-food products, an example of which is represented by the capsules for infusion type beverages, e.g. coffee, a product to which reference will be made below without loss of generality.

In particular, in this technical field, production and packaging apparatuses are known in which a plurality of containers are individually filled with the product to be packaged, e.g. coffee powder, and then, after being closed by a special membrane, are packaged in special boxes and sent to the final packaging step. Production apparatuses of this type may comprise several operating units, arranged in a sequence to form a production line, with each operating unit carrying out specific processing operations on the containers until the final product is obtained.

These processes can be very different from each other, and may also involve other components intended to cooperate with the container to obtain the final product, such as, for example, a protection disc which may be inserted in the bottom of the container, a filter, coupled to the inside of the container, a powdered product poured in and intended to contain the powder of the infusion type beverage, a closing membrane, and possibly also a label.

In very general terms, each operating unit is subject to possible malfunctions that may lead to a non-conformity of the processed article with the required quality standards, which implies the need to plan a control of the processed articles in order to identify those that do not conform and, consequently, to discard them.

The types of controls that can be carried out on articles during or at the end of a process are varied, depending of course on the characteristics to be controlled, and include, among others, optical, gravimetric, dimensional and spectrophotometric controls.

In this description as well as in the accompanying claims, certain terms and expressions are deemed to have, unless otherwise expressly indicated, the meaning expressed in the following definitions.

The term “article” means any object apt to be processed in a production process or to be obtained by a production process involving more than one operating unit.

An article can therefore be a final product, i.e. a semi-finished product.

The articles can be identical to each other, or they can differ from each other in some characteristics such as the formation, the composition or the colour.

The articles can be, for example, food and confectionery products already packed in individual containers or wrappers, such as coffee capsules or other infusion drinks, bottles and cartons of beverages, yoghurt pots, individual chocolates (wrapped or bare), candies, small boxes, pouches containing solid, liquid or semi-solid food products; moreover, products of the ceramic industry, absorbent products for hygienic use, products of the tobacco industry, products of the cosmetic industry, products of the pharmaceutical industry, products of the personal & home care industry.

A process or a step thereof, in particular a processing carried out by an operating unit, is carried out “continuously” when the article on which the processing is carried out is moved by a transporter which, during that process or during that step, has a speed other than zero.

An article is subjected to a “processing” when a characteristic of the article is changed, such as its shape, orientation, colour, the overall composition (e.g. by being coupled or combined with other components or other products), or even its arrangement with respect to other articles.

Within a production apparatus comprising several operating units which are provided to carry out a succession of processing operations on an article, “process index” means the set of all the different operating configurations taken up successively in a cyclical manner by the operating units as successive articles enter the production process.

The process index, also known in the industry as the “virtual logical axis” or simply “virtual axis”, is particularly useful when processing operations on articles are carried out by operating units that are synchronised with each other and comprise several moving members working on the articles in a cyclical manner, such as when the moving members are mounted on a carousel-type transporter device. In this case, in fact, the moving members operate in cyclic succession on the articles fed to the operating unit, so that after a number of steps equal to the number of moving members the operating unit always has the same operating configuration.

To this end, it should be noted that the “configuration” of an operating unit is defined by the relative position of the moving members assigned to carry out a processing operation on a single article.

By way of example, in a container filling unit comprising 8 filling moving members mounted step by step on a carousel device, a process step can be defined each time a filling moving member picks up an article to fill it. It can be noted that the filling unit will always have the same operating configuration after 8 process steps.

When there are operating units with different numbers of moving members in the processing operation, the possible configurations defining the aforesaid process index are the lowest common multiple of the number of moving members in the various operating units.

In other words, the process index takes a snapshot of the configuration of each operating unit when a new article is introduced into the production process. This set of configurations of the different operating units defines a process index step. It should be pointed out that several articles may be introduced into the process or operating unit at the same time, provided that they are taken over by separate moving members.

It should be noted that “moving members” in this context means the number of devices capable of performing a processing operation on a single article. The moving members can be arranged in the operating unit in series one after the other or they can be arranged in successive groups, for example in pairs.

A “characteristic” of an article is “in accordance” with predetermined quality parameters when that characteristic meets specific requirements of the final product.

In this sense, the characteristic being controlled is to be understood in a general sense and, in particular, can be both a characteristic measurable in quantitative terms (such as a weight or a dimension) and assessable in qualitative terms (such as the integrity or the presence or, again, the shape of an article or a component).

The Applicant has preliminarily observed that in a process of production of articles, the control of the processing operations carried out, besides guaranteeing the compliance of the articles with the required quality parameters, also allows a more efficient management of the production process, for example by promptly identifying possible malfunctions of the operating units and thus allowing their rapid and punctual corrective intervention.

The Applicant has further observed that, in general, articles are controlled downstream in the production process and, if they do not meet the quality parameters, they are discarded before being sent for final packaging.

The Applicant, however, has verified that when the processing that leads to the non-conformity of the article is not the last one envisaged in the production process, it happens that the non-conforming article is also subjected to all the processing subsequent to the one that led to its non-conformity.

The Applicant has noted that such an event may, however, lead to further inconveniences in the subsequent processing, including the possibility of dispersal of materials in the production apparatus or, in the worst cases, even the possibility of damage to subsequent operating units and the halting of production.

Moreover, the Applicant has observed that subjecting a non-conforming article to one or more subsequent processes in any event entails a waste of energy and, possibly, material, with a consequent negative impact on both production costs and the environment.

The Applicant has therefore considered the possibility of carrying out control operations immediately downstream of the most critical processing operations and immediately discarding any articles which, following such processing, prove to be non-conforming.

However, the Applicant has ascertained that this possible solution, which requires the multiplication of control stations and the rejection of non-conforming articles, entails numerous drawbacks, including a significant increase in the overall size of the production apparatus and in production costs. Moreover, the Applicant has verified that these problems are further amplified when the production apparatus operates continuously and at high production speeds, as a direct consequence of the reduction in cycle times.

However, the Applicant has perceived that the above-mentioned drawbacks can be overcome by identifying along the production process the conforming and non-conforming articles and, while having them all continue along the apparatus together, selectively disabling the downstream operating units so as to avoid, at least in part, that they perform unnecessary processing on the non-conforming articles.

Finally, the Applicant has found that a control method of a production process of articles which envisages the steps of controlling the quality of the articles downstream of a first operating unit, identifying the non-conforming articles, making them continue in the production process together with the conforming articles, having however the precaution of partially disabling the downstream operating units, in such a way that the latter regularly carry out the envisaged processings on the conforming articles and avoid, as far as possible, carrying out such processing on the non-conforming articles, allows on the one hand to avoid unnecessary processing on articles which are in any case destined to be discarded, with consequent energy and possibly material saving, at the same time avoiding disruption to the normal flow of articles along the production process.

Thus, in a first aspect thereof, the present invention is directed to a method for controlling a process for producing articles.

Preferably, said method comprises the step of feeding a plurality of articles to a first operating unit, which is provided to subject said articles to a first processing operation.

Preferably, said method comprises the step of controlling at least one characteristic of said articles outgoing from said first operating unit.

Preferably, said method comprises the step of controlling at least one characteristic of said articles outgoing from said first operating unit.

Preferably, said method comprises the step of identifying among said articles a first group of articles, in which said characteristic is in accordance with predetermined quality parameters.

Preferably, said method comprises the step of identifying among said articles a second group of articles in which said characteristic is not in accordance with said predetermined quality parameters.

Preferably, said method comprises the step of transferring said articles outgoing from said first operating unit to at least one second operating unit which is provided to subject said articles to at least one second processing operation.

Preferably, said method comprises the step of allowing said at least one second processing unit to carry out said at least one second processing operation on said first group of articles.

Preferably, said method comprises the step of preventing, at least partially, said at least one second operating unit from carrying out said at least one second processing operation on said second group of articles.

Preferably, said method comprises the step of receiving said articles outgoing from said at least one second operating unit.

Preferably, said method comprises the step of discarding said second group of articles.

In a second aspect thereof, the present invention is directed to an apparatus for producing articles.

Preferably, said apparatus comprises a first operating unit designed to subject these articles to initial processing.

Preferably, said apparatus comprises at least a second operating unit, which is provided to subject said articles to at least one second processing operation.

Preferably, said apparatus comprises a detection system, which is provided to detect at least one characteristic of said articles between said first operating unit and said at least one second operating unit.

Preferably, said apparatus comprises a control unit of said apparatus, connected to said detection system.

Preferably, said control unit is arranged to control the conformity of said articles to predetermined quality parameters of said characteristic.

Preferably, said control unit is arranged to identify among said articles a first group of articles, in which said characteristic is in accordance said predetermined quality parameters.

Preferably, said control unit is arranged to identify among said articles a second group of articles in which said characteristic are not in accordance with said predetermined quality parameters.

Preferably, said control unit is arranged to control said at least one second operating unit to carry out said at least one second processing operation on said first group of articles.

Preferably, said control unit is provided to control said at least one second operating unit to prevent, at least partially, from carrying out said at least one second processing operation on said second group of articles.

Preferably, said apparatus comprises a discard station which is positioned downstream of said at least one second operating unit and which is provided to discard said second group of articles.

With these features, it is possible to efficiently control an article production process involving several operating units in series with each other, avoiding the provision of costly and cumbersome discard stations downstream of each operating unit and, at the same time, avoiding wasting resources (energy or material) on articles already destined to be discarded.

The control method of the invention also allows the flow of workpieces in the various operating units to be undisturbed, so that it is particularly suitable for continuous processes, and processes with high production capacities, making the production apparatus more cost-effective and more efficient.

In a third aspect thereof, the present invention is directed to a method for the optical inspection of articles.

Preferably, said method comprises the step of identifying a surface to be controlled of said article.

Preferably, said method comprises the step of arranging a plurality of cameras pointed at said article in order to capture images of said surface to be controlled.

Preferably, said cameras are positioned in such a way that in each image captured by each of said cameras there is defined a central region, in which said surface to be controlled is more into focus, and a peripheral region, in which said surface to be controlled is less into focus.

Preferably, said central region corresponds to a zone proximal to an optical axis of said camera.

Preferably, said peripheral region corresponds to a zone distal from said optical axis of the camera, more preferably to a zone of said image complementary to said central zone.

Preferably, said cameras are positioned in such a way that each portion of said surface to be monitored is detected by at least one camera at its central region, or by at least two cameras at the respective peripheral regions.

Preferably, said method comprises the step of capturing, by means of said cameras, respective images of said surface to be controlled.

Preferably, said method comprises the step of analysing said images to identify any non-conformities associated with said surface to be controlled.

With this method, it is advantageous to be able to control the surfaces of complexly shaped articles, such as the internal surfaces of cylindrical, truncated-conical or truncated-pyramidal containers with a generally irregular shape, effectively by analysing images captured by cameras.

In particular, the method makes it possible to effectively and precisely control surfaces characterised by the presence of a significant number of projections and depressions, by exploiting the possibility of analysing images of each portion of interest of the surface to be controlled that is in a central region of the image of a camera (and therefore perfectly focused) or that is present in at least two images captured by cameras placed at different angles.

The identification of the central region and the peripheral region of the images captured by the different cameras depends on several factors, firstly on the optical characteristics of the cameras, their positioning with respect to the surface to be controlled and the shape of the latter, and must be assessed on a case-by-case basis, depending on the degree of precision required for analysing the images.

In at least one of the aforesaid aspects, the present invention may also have at least one of the preferred features set out below.

Preferably, wherein said articles, after having controlled said characteristic, are subjected to a plurality of processing operations in successive operating units and each of said successive operating units is allowed to carry out a respective processing operation on said first group of articles and is prevented, at least partially, from carrying out said respective processing operation on said second group of articles.

In this way, savings in energy and possibly material resources are extended to the entire portion of the apparatus downstream of the quality control that identified the non-conforming article.

Preferably, said second group of articles is discarded at the end of said production process.

In some embodiments, more than one control operation of said articles are envisaged downstream of one or more operating units, and said second group is formed by all articles identified as non-conforming in at least one of said control operation.

In this way, by replicating the same inventive concept on each control in the processing operation, the benefits can also be multiplied.

Preferably, said operating units are synchronised with each other.

In this way, it is possible to establish a correspondence relationship between the configurations of an operating unit and the configurations of the other operating units of the production apparatus, also allowing to define a temporal sequence of process steps in which the configurations of the operating units are predetermined.

Preferably, said first processing is carried out by said first operating unit by means of a plurality of moving members, and, more preferably, each moving member is intended to operate on a different article.

In this way, by processing several articles with different moving members, which can operate in parallel or staggered to each other in time, it is possible to increase the production capacity of the first process.

In some embodiments, said first processing is carried out continuously, while said articles are moving.

This further promotes the possibility of first processing on articles at high production speeds.

In some embodiments, said at least one second processing is carried out by said at least one first operating unit by means of a plurality of moving members, and, more preferably, each moving member is intended to operate on a different article.

Preferably, said at least one second processing is carried out continuously while said articles are moving.

Preferably, the entire production process of the articles is carried out continuously.

In some embodiments, a process index is defined as the set of all the different operational configurations taken up successively in a cyclical manner by said operating units as successive articles enter the production process.

The definition of such a process index advantageously allows the identification of the temporal succession of operating configurations in which the different operating units may be found.

Preferably, each of said articles is uniquely associated with a step number of said process index.

In this way, for each article, it is possible to uniquely identify the configuration of the operating units that will carry out (or have carried out) the respective processing on that article.

In fact, when an article enters the production process, it finds the various operating units of the production apparatus in a given operating configuration (i.e. it enters a given step of the process index) and, given that the operating units are synchronised with each other and therefore that the successive operating configurations of the operating units are all marked by the regular succession of the steps of the process index, the operating configuration of the apparatus found by the article when it is subjected to any subsequent processing, remains, in fact, uniquely determined.

In other words, once entered into the process, the subsequent route of an article is predetermined and cannot be changed.

This unique association between the articles that move along the production process and the operating configurations of the different operating units that carry out the respective processing operations on these articles allows a very precise control of the operating units.

In some embodiments, the identification of an article as belonging to said second group is done by recording a non-conformity on a scroll register defined in said control unit.

This scroll register records all the events and information relating to the different processes carried out on each article from the beginning to the end of the process and, in particular, the evaluation of non-conformity of an article during a quality parameter control can be advantageously recorded.

This recording allows the control unit, for example, to accurately identify the articles to be discarded at the discard station.

In addition, it allows the selective and temporary (at least partial) disabling of moving members called upon to carry out their processing on articles identified as non-conforming.

The disabling of operating units in the processing of articles identified as non-conforming may be complete or partial, depending on the processing to be carried out and, if necessary, on those already carried out.

In particular, the disablement will be total, i.e. the non-conforming article will pass through at least one operating unit without undergoing any envisaged processing in that operating unit, in all cases where this does not lead to greater disadvantages in the continuation of the process than the savings obtained by not processing. In the latter cases, the non-conforming article is expected to undergo minimal processing (partial disabling of the operating unit) in order not to cause such inconvenience, while still achieving a minor saving.

An example of total disabling is when an empty capsule is detected as defective at the start of the process, so that all downstream processings, such as filling it with coffee powder and closing it with a membrane, can be completely disabled.

An example of partial disabling is when a capsule is detected as defective after the step of filling with coffee powder. In this case, it will still be advisable to close the capsule with a lid, to prevent the coffee powder from escaping from the capsule and being dispersed into the environment. However, the operation of closing the capsule may be carried out in a partial manner, e.g. for a shorter period of time, which is in itself inadequate to guarantee the airtightness of a finished capsule according to normal quality standards, but sufficient to avoid the dispersion of powder into the environment at least until the station where the non-conforming articles are discarded.

A further important advantage of this feature of the invention is the possibility of detecting malfunctions of a specific moving member within an operating unit. In fact, by analysing the respective steps of the process index of the non-conforming articles, it is possible to identify exactly which moving members of the different operating units have worked on them and, therefore, any malfunctioning moving members can be identified. This has the advantage of reducing the time for identifying the malfunction and possible downtime, so that the necessary correction procedures can be activated in good time.

Preferably, the step number of said process index is printed on each article.

In this way, in the event that the possible non-conformity of one or more articles is only detected downstream in the production process, in particular on the final product, it is possible to trace back to the moving members which worked on that article so that any malfunction can be identified.

Preferably, the step number of said process index is printed at the end of said process.

In some embodiments, if a moving member of an operating unit of said apparatus is disabled, all processings of the other operating units involving articles having a step number of said process index including this disabled moving member are disabled.

In this way, it is possible to exclude a specific moving member of an operating unit, e.g. for maintenance, without necessarily interrupting the normal operation of the other moving members of the operating unit.

In fact, in this case, it will only be possible to disable the entry of an article into the process at a given step of the process index where the excluded moving member is used.

In some embodiments, said characteristic is controlled by an optical detection system.

Alternatively or additionally, the detection system may be of a different type, e.g. gravimetric or, more generally, may be based on the use of radiation or electromagnetic fields.

In one embodiment, said first operating unit comprises an assembly process of a component on one of said articles and said control comprises the control of said assembly process by means of an optical detection system.

Preferably, said control by means of said optical detection system is carried out according to the method of the aforesaid third aspect.

In one embodiment, said article is a capsule inside which a filter is assembled.

Preferably, said surface to be controlled is the surface of said filter assembled to said capsule.

Preferably, said surface to be controlled has a truncated conical shape with a bottom and a lateral wall.

Preferably, said filter is coupled to said capsule at its upper edge which is opposite to said bottom.

Preferably, said lateral wall is pleated.

Preferably, said cameras are placed over a mouth of said capsule in order to be able to acquire images of said lateral wall and of said bottom.

Preferably, said cameras are positioned above said capsule at a height between 100 and 200 mm.

Preferably, said cameras are coplanar with each other, more preferably they are arranged in a plane parallel to said mouth.

In one embodiment, this central zone corresponds to a viewing angle of 90° centered on said optical axis.

Preferably, at least 90% of the surface of said lateral wall, and more preferably the entire surface of said lateral wall, is part of a central region of one of said cameras.

In this way, the most critical surface to be controlled, i.e. the lateral wall of the filter, is analysed under the best focusing conditions.

Preferably, the optical axis of said cameras is pointed towards said lateral wall, more preferably at a median height between said mouth and said bottom.

Preferably, the optical axis of said cameras is inclined at an angle between 45° and 70° with respect to said bottom of said filter, more preferably between 55° and 60°.

In one embodiment, a central portion of said bottom is part of at least two peripheral regions of said cameras.

In this way, the central portion of the filter bottom is analysed by exploiting the redundancy of images taken from different angles, thus compensating for the fact that it is not perfectly into focus.

In one embodiment, said cameras are four and, preferably, they are positioned at the vertices of a square.

In one embodiment, said optical detection system comprises a lighting device, which is provided to illuminate said surface to be controlled while said cameras acquire said images.

Preferably, said lighting device is unique for all cameras.

Preferably, said lighting device is interposed between said cameras and said surface to be controlled, outside the field of view of said cameras.

Preferably, said lighting device has an annular shape.

Preferably, said characteristic is controlled while said articles are moving.

In some embodiments, said articles are fed at a speed of more than 500, more preferably more than 1000 articles per minute, even more preferably more than 1200 articles per minute.

In some embodiments, said articles are capsules for infusion type beverages, e.g. coffee.

In some embodiments, said first operating unit and said at least one second operating unit of said production apparatus comprise a unit for feeding empty capsules, a unit for filling the empty capsule with an infusion type beverage powder, and a unit for closing the capsules.

More preferably, said first operating unit and said at least one second operating unit of said production apparatus further comprise, between said feeding unit and said filling unit, a filter coupling unit to said respective empty capsules, and, even more preferably, comprise, prior to said coupling unit, a filter forming unit to be coupled to said empty capsules.

Preferably, said first operating unit comprises a first transport member on which a plurality of first moving members are mounted and said articles are subjected to said first processing operation by said first moving members while they are being moved by said first transport member.

In this way, it is possible to carry out the first processing of the articles in a continuous manner.

Preferably, said at least one second operating unit comprises at least one second transporter member on which a plurality of respective second moving members are mounted and said articles are subjected to said at least one second processing operation by said respective second moving members while they are being moved by said at least one second transport member.

In this way, it is possible to carry out the second processing of the articles, and possibly also all the processing downstream of the first processing, continuously.

The characteristics and advantages of the invention will become clearer from the detailed description of an embodiment illustrated, by way of non-limiting example, with reference to the appended drawings wherein:

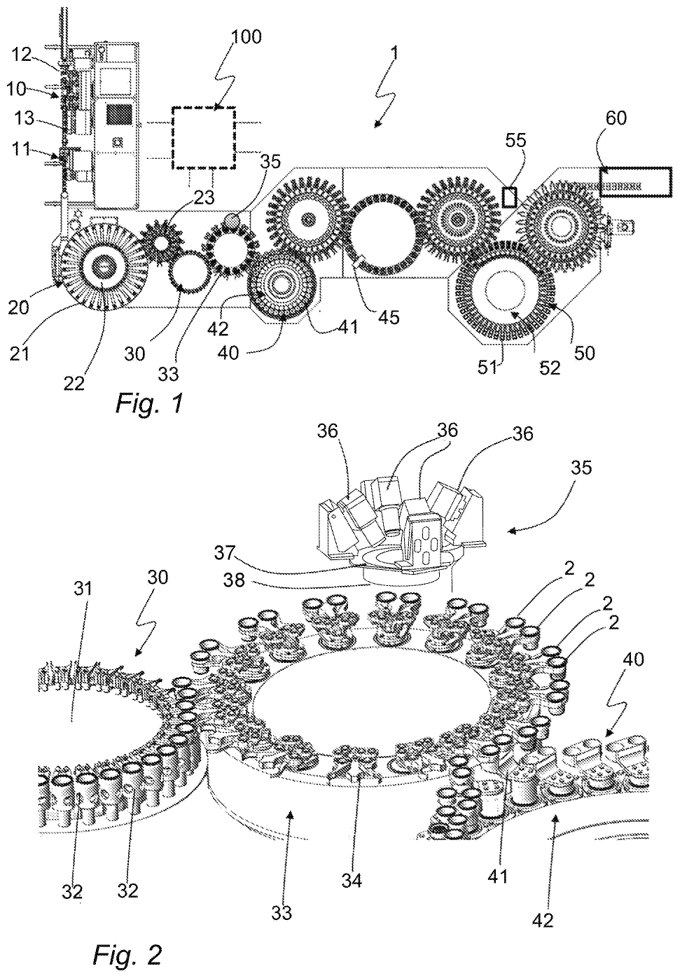

FIG. 1 is a schematic plan view from above of an article production apparatus operating according to the method of the present invention;

FIG. 2 is a schematic view in perspective from above and on an enlarged scale of a first section of the production apparatus in FIG. 1;

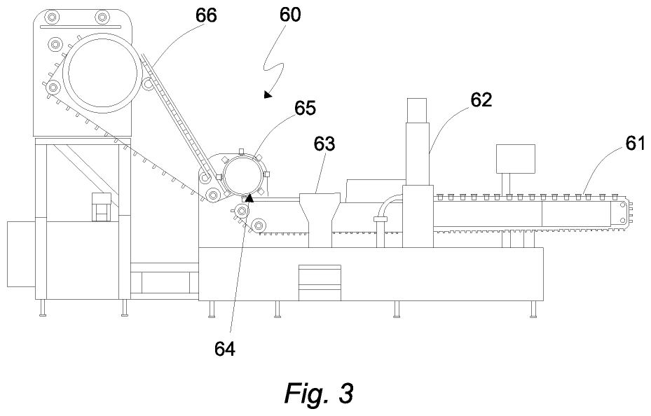

FIG. 3 is a schematic side elevation view of a second section of the production apparatus in FIG. 1.

With reference to the accompanying figures, 1 indicated an apparatus for articles 2 made to operate in accordance with the control method of the present invention.

In the embodiment example described herein, the production apparatus 1 is provided for the preparation of capsules for infusion type beverages, in particular coffee.

In this embodiment example, therefore, the articles 2 are formed by capsules, also indicated in the following with the same numerical reference, which in the development of the production process are gradually processed until they become, at the end of apparatus 1, capsules ready for packaging, packing and final dispatch.

In general terms, the apparatus 1 comprises an inlet unit 10 in which empty capsules 2 are fed, a filter shaping unit 20 in which a specially formed filter is inserted into each empty capsule 2, a coupling unit 30 in which the filters are coupled to respective capsules 2, a filling unit 40 in which the empty capsules 2 provided with a filter are filled with coffee powder, a closing unit 50 in which the capsules 2 filled with coffee are closed again by a membrane, as well as an outlet unit 60, in which the capsules are suitably selected and then sent to a packaging apparatus (not shown).

In the embodiment described herein, an auxiliary unit 11 is also provided between the inlet unit 10 and the filter forming unit 20, which is provided to deposit respective protection discs at the bottom of the empty capsules 2.

The capsules 2 are formed by a rigid casing, with a truncated conical shape, comprising a bottom from which a flared lateral wall extends towards a mouth opposite to the bottom. The bottom has a smaller cross-section than the mouth and, overall, the capsules have a diameter of between 20 and 60 mm and a height of between 15 and 60 mm.

Each of the units 10, 11, 20, 30, 40, 50, 60 listed above represents a respective operating unit of the production apparatus 1, and each of them is arranged to carry out one or more specific processing operations on the capsules 2 or components thereof.

The apparatus 1 operates continuously, so that the capsules 2 within the different operating units are subjected to the respective processing while being transported by a transporter member, which may be of the conveyor or carousel type, and are then transferred between successive operating units by means of transfer devices.

Advantageously, each article 2 is always retained, moved and processed individually, so that at any given time the position of an article 2 within the production apparatus 1 is always uniquely determined by the position of an operating unit or transfer device.

In other words, this means, for example, that in the production apparatus 1 there are no operating units in which processing operations are carried out on a random number of articles and that there are no random groupings or transfers of articles from one operating unit to another.

Therefore, all operating units are also synchronised with each other in order to enable the correct processing of the articles.

The inlet unit 10 comprises a singling device 12 which provides for extracting the single capsules from a pair of nested stacks of capsules and depositing them on a conveyor belt 13 where, during their path, they are provided, if envisaged by the process, with a protection disc deposited on their bottom at the auxiliary unit 11.

The empty capsules 2, possibly provided with a protection disc, are then transferred in a continuous row to the filter forming unit 20, where a filter is formed and positioned inside each empty capsule 2 thanks to the provision of special moving members 21 mounted on a rotating carousel 22.

The filter formed by the filter forming unit 20 is similar in shape to the capsule 2 into which it is inserted, except for its height. In particular, the filter has a truncated conical shape, comprising a substantially horizontal and smooth bottom, from which a flared lateral wall extends towards a mouth opposite to the bottom. The lateral wall is entirely pleated, with regular folds extending longitudinally from the mouth up to the bottom.

The capsules 2 and the relative filters are then transferred by an exchange wheel 23 to the coupling unit 30, where, on another rotating carousel 31 equipped with positioning and welding moving members 32, the filters are correctly positioned and welded inside the capsules 2. Specifically, the filter is welded at the upper crown of its lateral wall to the corresponding lateral wall of the capsule, near the respective mouth.

The capsules 2 provided with a filter are then removed from an exchange wheel 33 by means of special gripping elements 34, of the pincer type, and transferred to the filling unit 40, where they are filled with coffee powder thanks to special moving members 41 equipped with delivery devices, continuously transported on a rotating carousel 42.

After a series of further exchange wheels, the capsules 2 are brought to the closing unit 50 where they are closed with a lid at special welding moving members 51 arranged uniformly on a rotating carousel 52.

Downstream of the closure unit 50, the capsules 2, filled and duly closed, are transferred to the outlet unit 60, where the capsules 2 are marked, sampled and sorted before being transferred to the packaging apparatus.

Along the production apparatus 1 there are also provided several detection systems which are provided to acquire information regarding the capsules 2 or the components thereof which are useful to verify the quality of the processing carried out in one or more of the immediately preceding operating units.

In particular, each detection system is provided to control one or more characteristics of the articles or the components in order to verify their conformity with predetermined quality parameters.

Of course, the characteristics to be controlled depend on the specific processes carried out in the upstream operating units and can be very diverse, depending on the processes, articles and quality parameters to be met.

By way of example, in the production apparatus 1 there is provided a first detection system 35 between the coupling unit 30 and the filling unit 40, a second detection system 45 downstream of the filling unit 40 and a third detection system 55 positioned at the closing unit 50.

In particular, the first detection system 35 is provided to acquire the information necessary to verify both the integrity of the filter and its correct coupling inside the capsule 2, the second detection system 45 is provided to acquire the information necessary to verify the correct filling of the capsule with the coffee powder and the third detection system 55 is provided to acquire the information necessary to verify the correct positioning of the lid on a welding moving member 51 before welding it onto the respective capsule.

These detection systems are chosen according to the characteristic to be controlled and may therefore be based on different operating principles. For example, the first and third detection system 35 and 55 are of the optical type and are based on an analysis of images captured by special cameras, while the second detection system 45 can be of the gravimetric or microwave type.

The production apparatus 1 also comprises a control unit 100, which is provided to control the entire production process as well as each single operating unit and, of course, the associated detection systems.

First of all, a process index is defined in control unit 100 by the cyclic succession of all the different operating configurations assumed by the operating units as successive articles enter the production process. Each configuration assumed by the different operating units when a new article enters the process forms a step in the process index.

Since all operating units operate in synchrony with each other and there is no intermediate accumulation of articles, each article entering an operating unit corresponds to one article leaving the same operating unit and one article entering the next operating unit.

Furthermore, since each operating unit comprises one or more moving members that carry out the planned operations in a cyclic manner (thanks to the fact that they operate on a rotary carousel), each operating unit has the same configuration (i.e. the same arrangement of moving members) after a defined number of operations (corresponding to one complete turn of the carousel).

Therefore, it is always possible to identify a process cycle number, represented by the lowest common multiple between the moving member numbers of the single operating units, after which all the operating units re-present the same configuration (having each performed one or more complete cycles).

In other words, the configuration of all operating units of the production apparatus 1 will be the same for every number of process index steps equal to the aforesaid process cycle number.

In addition, each process index step can in turn be further subdivided into a number of sub-steps required for a more precise control of processings or events that take place in smaller time intervals than the process index step. For example, each process index step can be further subdivided into 360 sub-steps. The subsequent sub-steps and, consequently, each step of the process index is marked by an encoder.

In addition, a scroll register is defined in the operating unit 100, where all events and information deemed significant relating to each article from the entry thereof into the apparatus 1 until the exit the from the apparatus 1 are recorded.

Starting from these assumptions, to each new capsule 2 entering the production apparatus 1, for example when removed from the singling unit 12, the control unit 100 assigns a step number of the process index, which will uniquely define its path within the production apparatus 1 and, in particular, by which moving member of each operating unit it will be processed.

In the event that the singling unit 12 removes more than one capsule at the same time, an order of numerical succession will be established according to the position of the removed articles.

In the following, in order to describe the present invention in detail, specific reference will be made to the first detection system 35 interposed between the coupling unit 30, which thus represents a generic first operating unit of the production apparatus 1, and the filling unit 40, which thus represents a generic second operating unit of the production apparatus 1. Accordingly, the rotary carousel 31 thus represents a generic first transport member, the positioning and welding moving members 32 represent a generic plurality of first moving members, while the rotary carousel 42 represents a generic second transport member and the moving members 41 represent a generic plurality of second moving members.

It is understood that what is stated with respect to the first detection system 35 and the respective coupling units 30 and filling units 40 will, however, be similarly reproducible in the other detection systems mentioned above.

As better visible in FIG. 2, the detection system 35 is positioned at the exchange wheel 33, which is interposed between the coupling unit 30 and the filling unit 40, and comprises four cameras 36 capable of acquiring one or more images of the capsules 2 being transferred between the two operating units.

The cameras 36 of the detection system 35 are arranged coplanar to the vertices of a square and, in particular, are mounted on a support plate 37, which is horizontal and has a large central hole through which the cameras are pointed.

The cameras 36 are placed at a height of about 150 mm from the mouth of the capsules 2 and are tilted downwards in such a way that their optical axis is inclined by about 55° to 60° with respect to the horizontal plane.

An annular-shaped lighting device 38 is also positioned at the hole of the plate 37, facing downwards and synchronised with the cameras 36 to illuminate the capsule 2 and the filter inside it from above with diffuse light.

The cameras 36 are pointed in a fixed manner towards a point on the path of the exchange wheel 33, where the capsules 2 pass continuously.

In particular, the cameras 36 are oriented so as to capture images of the bottom and the pleated lateral wall of the filter, with special attention to the welding area between the filter and the capsule, which together form the surface to be controlled by the optical control system.

Advantageously, the optical axis of the cameras 36 is pointed towards the lateral wall of the filter, at a median height between the mouth and the bottom. The cameras 36 have a suitable focal distance, for example 16 mm, which allows them to frame the capsule 2 and the filter coupled thereto from above with a framing of about 70 mm×50 mm.

Within this frame, a central region is defined, substantially corresponding to a region proximal to the optical axis, in which the focus can be considered optimal, and a peripheral region, in which the image is slightly blurred.

Thanks to the characteristics of the cameras 36 and their specific arrangement, the central region of each camera 36 covers a lateral wall sector of the filter developed over an angle of about 90°, centred on the respective optical axis.

In this way, the entire lateral wall of the filter, which due to pleating is more difficult to analyse precisely, is part of a central region of a camera 36. In addition, a large part of the lateral wall is also part of a peripheral region of a camera 36.

As for the bottom of the filter, in turn, it may be part of a central region of an image of a camera 36, or, for example its most central portion, may be part of the peripheral region of several cameras 36, preferably all four cameras 36.

The images captured by the cameras 36 are immediately analysed by the control unit 100, by means of a special algorithm, in order to verify the integrity of the filter, its correct shaping, its correct positioning inside the capsule, and the correct coupling between filter and capsule.

This analysis is carried out in real time (a few tens of milliseconds) and makes it possible to identify the conformity of these characteristics with the required quality parameters.

On the basis of this analysis, a first group of capsules that meet these quality parameters and a second group of capsules that do not meet these quality parameters are identified.

In particular, all capsules 2 of the second group are uniquely identified by recording this non-conformity on the slide register at their specific process index step number.

The capsules 2 of both the first and second groups are carried by the exchange wheel 33 to the subsequent operating unit, namely the filling unit 40, where each capsule is picked up by a respective moving member 41.

However, the moving members 41 taking over a capsule 2 belonging to the second group, i.e. a capsule identified as non-conforming, are substantially disabled, so that they are moved along the filling unit 40 without, however, being filled with coffee powder.

Similarly, all capsules 2, both those identified at the first detection system 35 as conforming and those identified as non-conforming, are fed to the closure unit 50.

The capsules 2 identified as non-conforming, however, even though they are received by the respective welding moving members 51 and moved by the rotating carousel 52 are not closed by a corresponding lid, saving both the lid and the corresponding welding operation.

Downstream of the closure unit 50, the capsules 2 are then transferred to the outlet unit 60.

Here, as is better visible in FIG. 3, the capsules 2 are transported by a conveyor 61 to a marking station 62, where certain data relating to the product, such as the batch number, the expiry date, and other data relating to the production process, including, in particular, the step number of the process index associated with each single capsule, are printed by laser.

In this way, it is possible to precisely identify the moving members that have carried out each individual processing on each individual capsule 2, even when the capsules have already left the production apparatus 1, for example during packaging, packing steps or even later when they are placed on the market.

The outlet unit 60 further comprises a sampling station 63, wherein some capsules 2 are picked up for possible statistical quality sampling and, finally, a discard station 64, wherein the capsules 2 of the first group (i.e. the capsules found to be conforming as a result of the analysis derived from each detection system) are separated from the capsules 2 of the second group (i.e. the capsules found to be non-conforming as a result of the analysis derived from at least one detection system).

In particular, the discard station 64 comprises an exchange wheel 65 which selectively picks up the capsules 2 of the first group to take them to a transport device 66 intended for the packaging apparatus, leaving instead on the conveyor 61 the capsules 2 of the second group intended to fall into a waste collection container (not illustrated) provided at the end of the conveyor 61.

All the actions of enabling and disabling the moving members of the various operating units up to the final selection of the exchange wheel 65 of the discard station 64 are easily managed by the control unit 100 thanks to the recording of any non-conformities on the scroll register as well as the provision of the process index and the unique association of each step with each capsule that enters and is processed in the production apparatus 1.

The control unit 100 also manages in a substantially similar manner the quality controls carried out on the capsules 2 by the second detection system 45 and the third detection system 55.

In particular, the second detection system 45 verifies, downstream of the filling unit 40, that the quantity of coffee powder fed into each capsule 2 is in accordance with the required weight values.

If, as a result of this control, a capsule 2 is found with non-conforming values, 20 this capsule is also identified as belonging to the second group and its non-conformity is recorded in the slide register.

In this case, however, it is envisaged that the welding moving member 51 taking charge of a capsule 2 identified as non-conforming following the analysis resulting from the second detection system 45 will only be partially disabled.

In particular, it is envisaged that such a capsule will still be closed by a lid, even if it is not completely sealed or only partially sealed.

This prevents the coffee powder in the capsule from being dispersed into the environment and at least ensures that the capsule remains closed at least until the capsules discarded from the production process are disposed of.

Similarly, the capsules 2 that are found to be non-conforming following analysis by the third detection system 55 which verifies, by means of optical analysis, the correct positioning of the capsule and lid before welding them, are treated. Also in this case, in fact, it is envisaged that the sealing moving member 51 intended to operate the sealing operation of the lid and of the capsule 2 identified as non-conforming is only partially disabled, so as to still close the capsule, already filled with coffee powder, with a lid only partially sealed or with a minimum level of sealing.

Should statistical sampling of the capsules 2 picked up at sampling station 62 show any additional non-conforming capsules, all moving members which processed these additional capsules would be easily identified by the process index step number printed on them.

All step numbers of the capsules identified as non-conforming as a result of statistical sampling or as a result of controls carried out during the process are also advantageously recorded and statistically verified, so as to identify any anomalies attributable to some specific moving member of an operating unit and to allow any targeted interventions.

Thanks to the features of the present invention, it is therefore possible to manage the production process of articles efficiently, guaranteeing the highest standards of quality control of the articles during their production without, however, placing limits on the production capacity and without increasing the costs and space requirements of the production apparatus.

It goes without saying that a person skilled in the art may, in order to meet specific and contingent application requirements, make further modifications and variants of the above-described invention within the scope of protection as defined by the following claims.

1.-18. (canceled)

19. A method for controlling a production process for articles, comprising:
feeding a plurality of articles to a first operating unit configured to subject said articles to a first processing operation,
controlling at least one characteristic of said articles outgoing from said first operating unit,
identifying among said articles a first group of articles, in which said at least one characteristic is in accordance with predetermined quality parameters, and a second group of articles, in which said at least one characteristic is not in accordance with said predetermined quality parameters,
transferring said articles outgoing from said first operating unit to at least one second operating unit configured to subject said articles to at least one second processing operation,
allowing said at least one second operating unit to perform said at least one second processing operation on said first group of articles,
preventing, at least partially, said at least one second operating unit from performing said at least one second processing operation on said second group of articles,
receiving said articles outgoing from said at least one second operating unit, and
discarding said second group of articles.

20. The method according to claim 19, wherein
said articles, after said at least one characteristic has been controlled, are subjected to a plurality of processing operations in successive operating units, and
each of said successive operating units is allowed to perform a respective processing operation on said first group of articles and is prevented, at least partially, from performing said respective processing operation on said second group of articles.

21. The method according to claim 19, wherein said second group of articles is discarded at the end of said production process.

22. The method according to claim 19, further comprising a control operations of said articles downstream of one or more operating units, wherein said second group is formed by all articles identified as not being in accordance with at least one of said control operations.

23. The method according to claim 19, wherein said first processing operation is performed by said first operating unit by a plurality of moving members, each moving member being configured to operate on a different article.

24. The method according to claim 19, wherein said first processing operation is performed in a continuous manner while said articles are moving.

25. The method according to claim 19, wherein said at least one second processing operation is performed by said at least one second operating unit by a plurality of moving members, each moving member being configured to operate on a different article.

26. The method according to claim 19, wherein said at least one second processing operation is performed in a continuous manner while said articles are moving.

27. The method according to claim 19, wherein
a process index is defined, the process index being formed by the whole of all different operating configurations taken up successively in a cyclical manner by said operating units during introduction of successive articles in the production process, and
each of said articles is uniquely associated with a step number of said process index.

28. The method according to claim 27, wherein the step number of said process index is printed on each article.

29. The method according to claim 28, wherein the step number of said process index is printed at the end of said process.

30. The method according to claim 27, wherein, when a moving member of an operating unit of said apparatus is disabled, disabling of all processing operations of the other operating units involving articles having a step number of said process index comprising the moving member being disabled occurs.

31. The method according to claim 19, wherein said at least one characteristic is controlled by an optical detection system.

32. The method according to claim 31, wherein said optical detection system comprises four cameras directed towards said article.

33. The method according to claim 19, wherein said at least one characteristic is controlled while said articles are moving.

34. A production apparatus for articles, comprising:
a first operating unit configured to subject said articles to a first processing operation,
at least one second operating unit configured to subject said articles to at least one second processing operation,
a detection system configured to detect at least one characteristic of said articles between said first operating unit and said at least one second operating unit,
a control unit for said apparatus, connected to said detection system and configured to:
i) control conformity of said articles with predetermined quality parameters of said at least one characteristic,
ii) identify among said articles a first group of articles, in which said at least one characteristic is in accordance with said predetermined quality parameters, and a second group of articles, in which said at least one characteristic is not in accordance with said predetermined quality parameters, and
iii) control said at least one second operating unit to perform said at least one second processing operation on said first group of articles and to prevent, at least partially, said at least one second processing operation from being performed on said second group of articles, and
a discarding station positioned downstream of said at least one second operating unit and configured to discard said second group of articles.

35. The apparatus according to claim 34, wherein
said first operating unit comprises a first transport member on which first moving members are mounted, and
said articles are subjected to said first processing operation by said first moving members while said moving members are being moved by said first transport member.

36. The apparatus according to claim 34, wherein
said at least one second operating unit comprises at least one second transport member on which respective second moving members are mounted, and
said articles are subjected to said at least one second processing operation by said respective second moving members while said respective second moving members are being moved by said at least one second transport member.
